(19) United States
(12) Patent Application Publication
(10) Pub. No.: US 2005/0256783 A1
(43) Pub. Date: Nov. 17, 2005

(54) Systems and methods for facilitating electronic business transactions

(76) Inventor: Richard W. Ettinger JR., New Canaan, CT (US)

Correspondence Address: McCARTER & ENGLISH, LLP;Attn: Anita Lomartra, CityPlace I, 185 Asylum Street, Hartford, CT, 06103, US

(21) Appl. No.: 11/120,236

(22) Filed: May 2, 2005

Related U.S. Application Data
(60) Provisional application No. 60/570,172, filed on May 12, 2004.

(51) Int. Cl. G06F 17/60

(52) U.S. Cl. 705/26

(57) ABSTRACT

Systems and methods are provided that offer or support one or more of the following features or functionalites: (i) facilitating integration of a module on a third party site, (ii) commercial transaction(s) involving “fixed-priced” keywords or phrases, (iii) associating a particular background color to a distinct item listing, (iv) commercial transaction(s) involving placement of transactional listings, (v) automated advertising positioning and placement listings, and/or (vi) real time automated accounting of inventory. The disclosed systems and methods are adapted for use as part of a network, e.g., the World Wide Web or the Internet.

### CROSS-REFERENCE TO RELATED APPLICATIONS

The present application claims the benefit of a co-pending provisional application entitled “Systems and/or Methods Facilitating Effective Electronic Business Transactions,” which was filed on May 12, 2004, and assigned Ser. No. 60/570,172. The entire contents of the foregoing provisional patent application are incorporated herein by reference.

### BACKGROUND OF THE DISCLOSURE

1. Field of the Disclosure

The present disclosure relates generally to various automated systems and methods for electronic transactions over a computer network, e.g., the Internet or the World Wide Web. More particularly, the present disclosure relates to a system for online marketplace data sharing and creating, a system for integrating a module on a third party site, a system for selling fixed-priced keywords or phrases, a system for associating a particular background color to a distinct item listing, a system for paying for placement of transactional listings, a system for advertising positioning and placement listings, and a system for real time automated accounting of inventory.

2. Discussion of Background Art

With the advent of widespread networked communication systems, business transactions are frequently undertaken through computer-based systems, e.g., over the Internet or the World Wide Web. Countless websites may be accessed that permit goods and/or services to be viewed and evaluated for potential purchase. Many websites facilitate the purchase of goods and/or services, generally at a price that is set forth at the website.

Typical online retail purchases are generally based on fixed prices that are either accepted or rejected by a prospective purchaser. In certain instances, a price benefit may be achieved by purchasing multiple items (e.g., three items for a dollar), or by purchasing in greater bulk. In addition, cost savings may be achieved through coupons, periodic “sales prices” and/or member/frequent customer discounts.

Some websites are suitable to support the sale/purchase of goods and/or services at prices that may vary from time-to-time and from user-to-user. Thus, for example, certain “auction sites” permit multiple individuals to “bid” on an item, e.g., a product or service, for a preset period of time. The individual that bids the highest price is generally successful in acquiring the item. Auction sites thus function as an electronic marketplace where buyers are able to view and bid on goods/services made available by participating sellers. A market leader in the field of web-based auction sites is “eBay” (www.ebay.com).

Still other websites are suitable to permit an individual to submit an “offer” for the purchase of goods and/or services, and such offer is either accepted or rejected based on criteria associated with design/operation of the website. For example, the “Priceline” website (www.priceline.com) permits individuals to submit offers for hotels, airfares and the like.

However, the “Priceline” site does not permit a potential purchaser to delineate all relevant parameters surrounding the desired goods/services, e.g., the precise hotel or precise air travel itinerary of interest. Moreover, websites like the “Priceline” site are unable to generate and/or communicate counter-offer(s) in response to offers that are deemed unacceptable.

Despite efforts to date, a need remains for automated systems and/or methods for supporting electronic communications involving goods and/or services that facilitate effective interactive communication, which is essential to electronic business transactions as numerous issues can come into play in conducting such transactions electronically, e.g., price, quality, quantity, delivery time, warranties, etc. Exemplary embodiments of systems and/or methods of the present disclosure satisfy the foregoing need, as described below.

### SUMMARY OF THE DISCLOSURE

The present disclosure provides advantageous automated systems and methods for supporting electronic communications involving goods and/or services that facilitate interactive communication. The effective interactive communication that is supported by the disclosed systems and methods is essential to electronic business transactions as numerous issues can come into play in conducting such transactions electronically, e.g., price, quality, quantity, delivery time, warranties, etc. Indeed, the present disclosure provides automated systems and methods for electronic transactions over a computer network, e.g., the Internet or the World Wide Web, that may be advantageously associated with a system for online marketplace data sharing.

According to exemplary embodiments of the present disclosure, the systems and methods offer or support one or more of the following features/functionalites: (i) facilitating integration of a module on a third party site, (ii) commercial transaction(s) involving “fixed-priced” keywords or phrases, (iii) associating a particular background color to a distinct item listing, (iv) commercial transaction(s) involving placement of transactional listings, (v) automated advertising positioning and placement listings, and/or (vi) real time automated accounting of inventory.

Thus, in a first exemplary embodiment of the present disclosure, a system and/or method for online marketplace data sharing is provided that includes:
(i) one or more electronic marketplace transaction (EMT) sites that appear independent; and
(ii) a single platform suitable for operatively connecting to the foregoing EMT sites so that while the EMT sites appear independent, the sites in fact share data,
   wherein the EMT sites may be divided into advantageous sub-groups.

In a second exemplary embodiment of the present disclosure, a system and/or method for integrating a listing module of a particular electronic marketplace transaction (EMT) site on one or more third party sites is provided, that includes:
(i) means for integrating a list of one or more discrete items and/or services on a third party site based on relevant content of the third party site in real time;
(ii) means for enabling one or more transaction methodologies; and
(iii) means for segregating and/or displaying the list of discrete items and/or services according to one or more criteria.

In a third exemplary embodiment of the present disclosure, a system and/or method for selling keywords and/or phrases for a fixed cost is provided, that includes:
(i) means for displaying one or more items associated with an electronic marketplace transaction (EMT) site when certain keywords and/or phrases are provided;
(ii) means for pricing one or more words and/or phrases; and
(iii) means for allowing a customer of the EMT site to purchase one or more words and/or phrases at a fixed price.

In a fourth exemplary embodiment of the present disclosure, a system and/or method for allowing a customer of an electronic marketplace transaction (EMT) site to list one or more items to be sold via an automated technique that accounts for two or more price/quantity breaks, that includes:
(i) means for allowing a customer of an EMT site to purchase and/or list items and/or services for sale with two or more price/quantity combinations;
(ii) means for displaying the two or more price/quantity break combinations;
(iii) means for displaying a total quantity of available items for instant purchase; and
(iv) means for tracking the total quantity of available items for instant purchase.

In a fifth exemplary embodiment of the present disclosure, a system and/or method for associating a particular color to an electronically displayed item is provided, that includes:
(i) means for selecting a desired color;
(ii) means for associating a selected color with a particular item and/or service; and
(iii) means for electronically displaying the particular item and/or service in association with the selected color.

In a sixth exemplary embodiment of the present disclosure, a system and/or method for paying for placement of transactional listings is provided, that includes:
(i) means for advancing one or more transactional listings for one or more items and/or services in accordance with an associated contribution amount;
(ii) means for controlling the duration over which items and/or services will be advanced;
(iii) means for ranking item and/or service listings according to contribution amount;
(iv) means for ranking items and/or services according to the time at which the items and/or services were listed; and
(v) means for providing and ranking one or more item and/or service listing subsection(s).

In a seventh exemplary embodiment of the present disclosure, a system and/or method for selective placement of advertisements is provided, that includes:
(i) means for posting one or more advertisements for items and/or services on a public electronic marketplace transaction (EMT) site according to the preferences of an EMT site customer;
(ii) means for cooperating with different advertising schemes; and
(iii) means for relocating the advertisements as certain placements/positions become unavailable.

In an eighth exemplary embodiment of the present disclosure, a system and/or method for simultaneous multiple electronic marketplace transaction selling methodologies is provided, that includes:
(i) means for providing an instant purchase feature;
(ii) means for providing a bid purchase feature;
(iii) means for providing a negotiated purchase feature; and
(iv) means for utilizing the instant purchase feature, the bid purchase feature and the negotiated purchase feature simultaneously with respect to one or more items and/or services for sale,
   wherein the utilizing means accounts for and readily displays current quantities available in real time.

Additional advantageous features and functionalities of the disclosed systems and methods will be apparent to persons skilled in the art from the detailed description, appended drawings and claims which follow.

### BRIEF DESCRIPTION OF THE DRAWINGS

So that those of ordinary skill in the art to which the subject disclosure pertains will more readily understand how to design and use the systems and methods of the present disclosure, exemplary embodiments will be described with reference to the drawings appended hereto, wherein:

FIG. 1 is block diagram of a system and/or method for online marketplace data sharing in accordance with an exemplary aspect of the present disclosure;

FIG. 2 is a block diagram of a system and/or method for integrating a listing module with a third party site in accordance with another exemplary aspect of the present disclosure;

FIGS. 3 and 4 are illustrative snapshots of WebPages utilizing a system and/or method for selling keywords and/or phrases in accordance with still another exemplary aspect of the present disclosure;

FIGS. 5 to 8 are illustrative snapshots of WebPages utilizing a system and/or method for automatically tracking a number of unit price/quantity breaks and total unit inventory in accordance with yet another exemplary aspect of the present disclosure;

FIGS. 9 to 11 are illustrative snapshots of WebPages utilizing a system and/or method for associating a color with a listed item and/or service in accordance with a further exemplary aspect of the present disclosure;

FIGS. 12 to 14 are illustrative snapshots of WebPages utilizing a system and/or method for paying for placement of transactional listings in accordance with still a further exemplary aspect of the present disclosure;

FIGS. 15 to 20 are illustrative snapshots of WebPages utilizing a system and/or method for selective placement of item and/or service advertisements in accordance with yet a further exemplary aspect of the present disclosure; and

FIGS. 21 to 25 are illustrative snapshots of WebPages utilizing a system and/or method for simultaneous multiple electronic marketplace transaction selling methodologies in accordance with yet still a further exemplary aspect of the present disclosure.

### DESCRIPTION OF EXEMPLARY EMBODIMENT(S)

The present disclosure is directed to various systems and/or methods for facilitating automated, real-time electronic business transactions. The disclosed systems/methods may be operated on any computer network, e.g., an intranet, extranet, wireless network, the Internet, the World Wide Web, and/or other networked computer systems. In addition, the disclosed systems/methods may be suitable to operatively cooperate with any of a variety of hardware and/or software. The exemplary aspects of the disclosed systems/methods advantageously permit at least the effective sale/purchase of goods and/or services electronically.

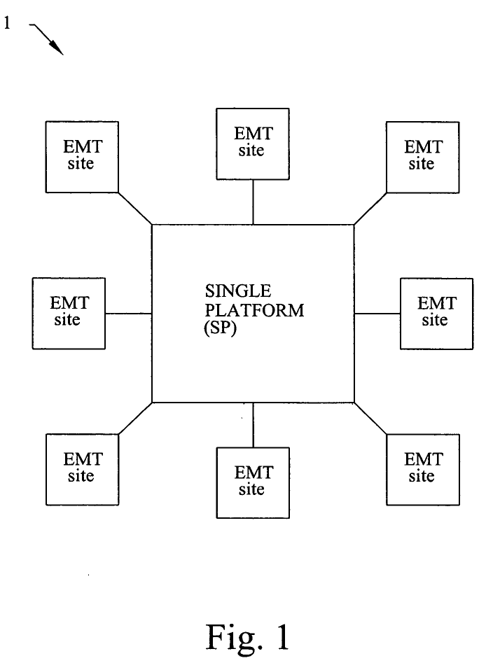

Referring to FIG. 1, a system 1, in one exemplary aspect of the present disclosure, is preferably well suited for online marketplace data sharing where one or more electronic marketplace transaction (EMT) sites operate on a single platform (SP) so that while the EMT sites appear independent such sites share data, e.g., user base, transaction items, and/or advertisements. In this aspect of the present disclosure, the EMT sites may be divided into any of a variety of sub-groups such as by category or geography. Accordingly the sub-groups advantageously enable a third party to access those EMT sites containing only data/items of interest. For example, in utilizing categorized sub-groups, the third party may access EMT sites categorized under a relatively broad sub-group, e.g., computers. Alternatively, the third party may access EMT sites categorized under a relatively narrow sub-group, e.g., hard drives. Further, in utilizing geographic sub-groups, the third party may access EMT sites geographically by location with respect to one or more geographic positions. One or more combinations of sub-groups may be utilized in combination and/or separately. In addition, an interface, which may be automated but need not, may be utilized to facilitate the development or set-up of one or more personalized online EMT sites. Thus, a user may directly set-up their own EMT site or, alternatively, may have an EMT site indirectly set-up for them via a service.

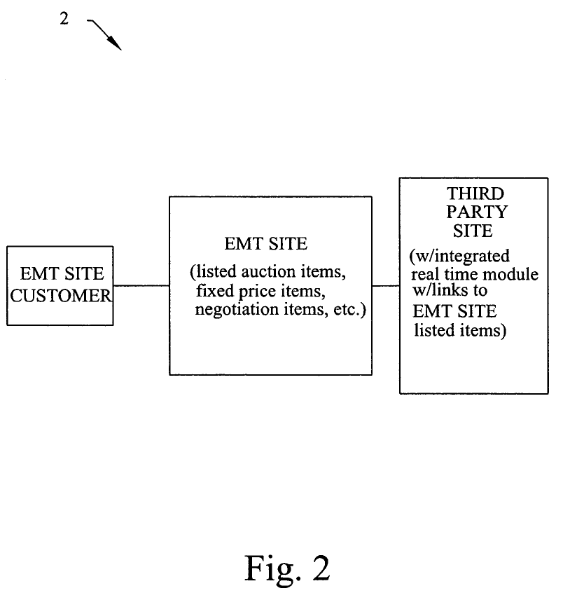

Referring to FIG. 2, a system 2, in accordance with another aspect of the present disclosure, is preferably well suited for integrating a listing module of a particular EMT site on one or more third party sites so that specific items listed by a customer of the EMT site may be accessed in real time via any one or more of the third party sites. For example, when an internet user visits any of the third party sites having links to the items listed by a customer of the EMT site, the internet user can, in real time, access the EMT site and conduct a transaction via one or more transaction methodologies, e.g., auction, negotiation and/or fixed priced. The system in accordance with this aspect of the present disclosure may be particularly advantageous to EMT site customers with listed items having a relatively short availability period for sale as such listed items may be effectively associated with the third party site based on a relevancy. That is, the relevance of the current content of the third party site may be appropriately associated with one or more particular items listed by EMT site customers. The content relevance may be determined in any of a variety of ways. Preferably, in this aspect of the present disclosure, an automatic spider or keyword technique may be utilized, and/or a user interactive direct keyword technique may be utilized (e.g., a user selects specific keywords associated with a particular listing module), and/or a user interactive indirect selection technique, e.g., a user selects a predefined link to display appropriate items of interest). The system in this aspect of the present disclosure may also be suitable to segregate the EMT customer item listings and/or display such item listings by any of a variety of different criteria, e.g., availability, timing, bidding, features, deals, etc.

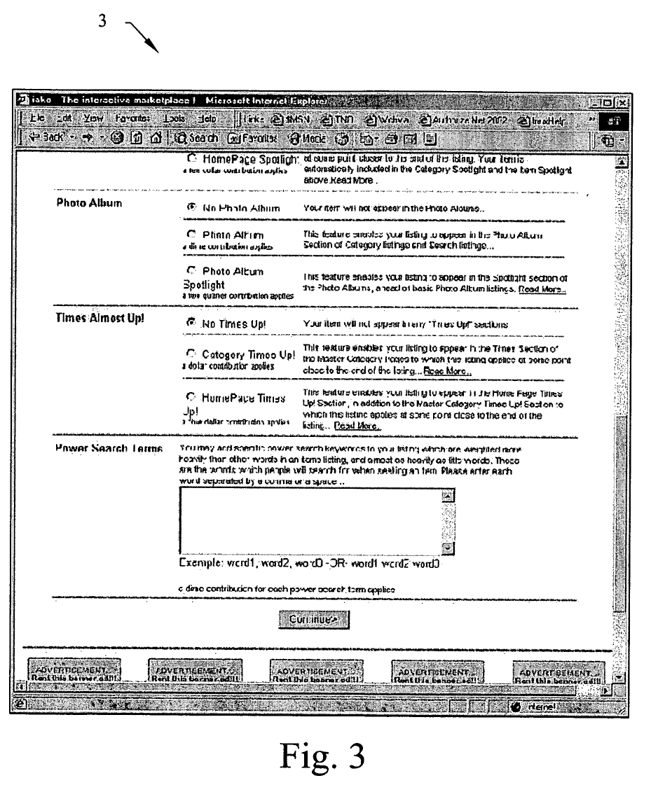

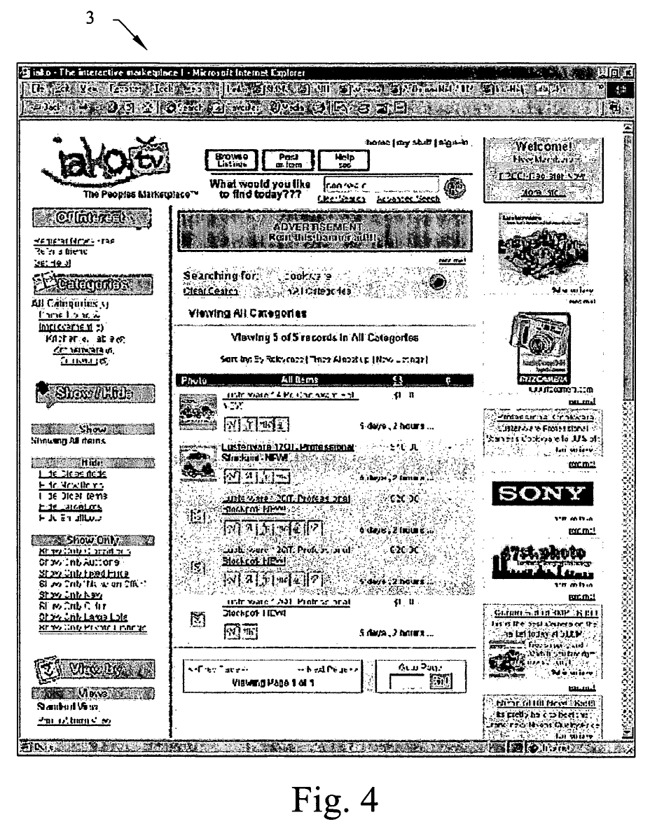

Referring to FIGS. 3 and 4, a system 3, in accordance with still another aspect of the present disclosure, may be well suited for selling keywords and/or phrases for a fixed cost so that one or more items associated with an EMT site customer appear when such keywords and/or phrases are provided via a search query, for example. In this aspect of the present disclosure, the system may use a word-specific fixed pricing structure and/or a phrase specific fixed pricing system. Other fixed pricing arrangements may also be used. The price associated with each word and/or phrase may be based on specific criteria, e.g., frequency of use, language specific, trademark related, etc. The system in this aspect of the present disclosure may also allow the EMT site customer to purchase multiple words and/or phrases for a rate or discounted fixed price. A relevance approach or technique may preferably utilized to connect one or more words and/or phrases associated with a listed sale item to one or more terms in a search query and/or a link. Preferably, in this aspect of the present disclosure, the keywords and/or phrases may be predefined terms specifically associated with items and/or services listed on the EMT site that are available for sell either currently or at a predetermined time in the future. Thus, the words and/or phrases, which are preferably purchased at a fixed price, may enable an EMT site customer to efficiently improve the overall exposure of a listed item and/or service for sale. In addition, the exposure or placement of a particular item and/or service need not be tied solely to the specific words and/or phrases purchased, but a combination of a combination of words in the title and/or body, or other factors may as well including, for example, other advancement features selected by the EMT site customers such as featured item listing, photo album listing, contributions to placement advancement and/or other like features.

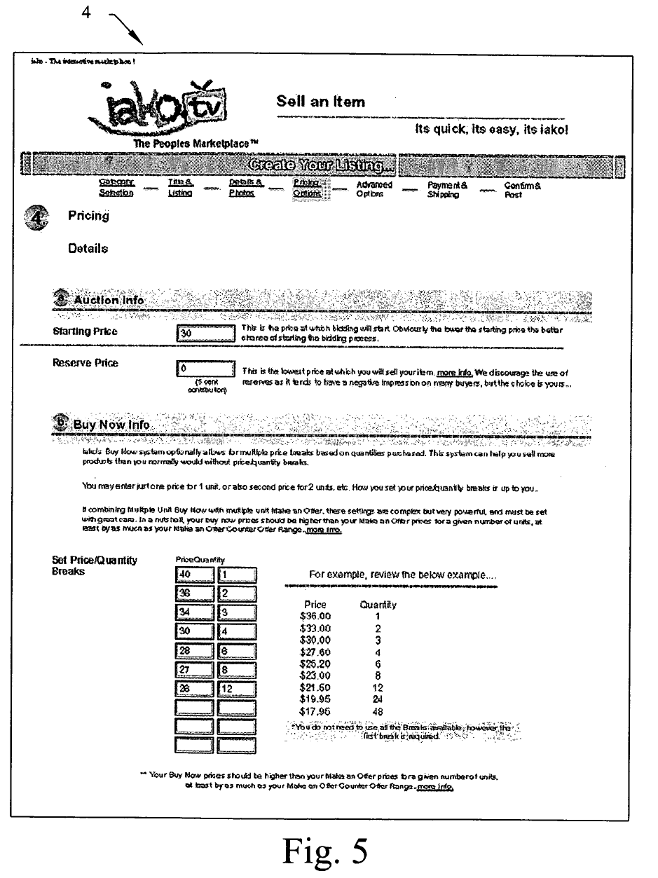

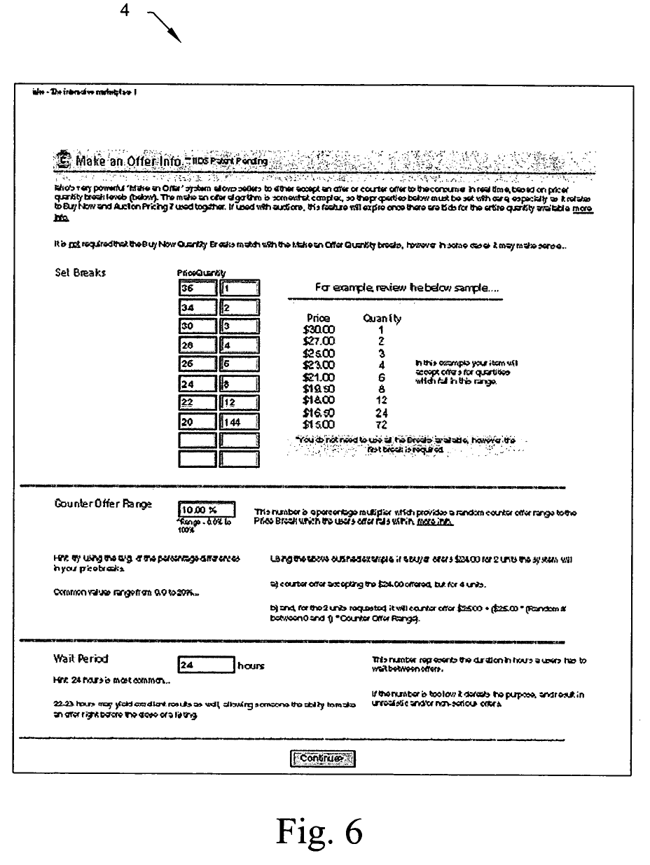

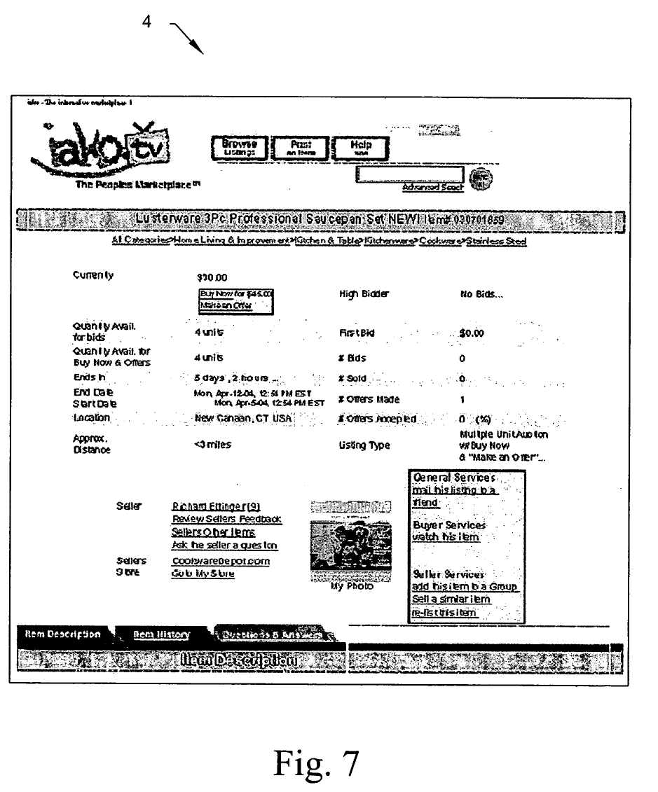

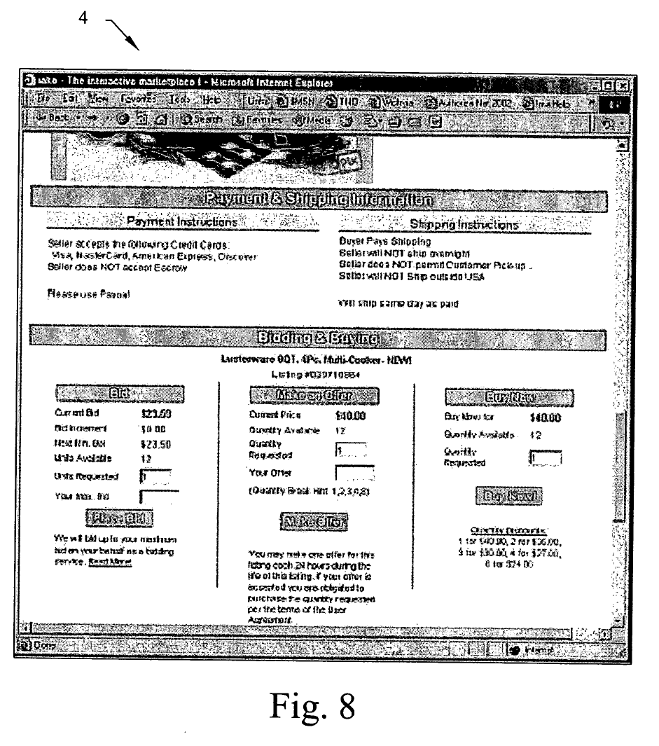

Referring to FIGS. 5 to 8, a system 4, in accordance with a further aspect of the present disclosure, is preferably well suited for allowing EMT site customers to list one or more items via an automated technique that accounts for a number of price/quantity breaks. The system, in this aspect of the present disclosure is also well suited for real time automated accounting of inventory. In this aspect of the present disclosure, the EMT site customers may purchase and/or list items for sale with one or more price/quantity combinations. The multiple price/quantity break combinations, as well as the total quantity of available items, may be displayed to public users, for example, when the EMT site customer's associated item is also displayed. Preferably, in this aspect of the present invention, the system is further well suited to track inventory and/or keep account thereof so that when items have been purchased or claimed via, for example, any of a variety of selling methods, e.g., auctions, fixed priced, etc., the total quantity available or remaining for instant purchase is appropriately reduced.

Further, should a quantity in a particular price/quantity break exceed the total quantity available for instant purchase that particular price/quantity break will no longer be displayed and/or available at least until the total quantity available for an instant purchase once again is more than the particular price/quantity break. As illustratively shown by Table 1 below, an EMT site customer may post or list an item and indicate that a predefined number of units are readily available for instant purchase at a predefined price according to any of a variety of different quantity/price break combinations.

TABLE 1

| QUANTITY | PRICE |
|---|---|
| (displayed in | (displayed in |
| real time) | real time) |
| 1 unit | first Price |
| 2 units | second Price |
| 3 units | third Price |
| 4 units | fourth Price |
| n units | nth Price |

TOTAL QUANTITY (displayed in real time)
TOTAL UNITS LESS UNITS PURCHASED/CLAIMED

Thus, according to this aspect of the present disclosure, if an EMT site customer has a total of 8 units available for instant purchase and 4 units are purchased/claimed at the predefined corresponding price, which price may be set by auction, by negotiation and/or directly by the EMT site customer, leaving a total quantity of 4 units available for instant purchase, only those quantity/price breaks that are available given the new total unit quantity will be displayed thereby ensuring more effective inventory management as well as user/purchaser satisfaction. It is noted that in a preferred aspect of the system 4, the quantity/price breaks and/or the total quantity available are both constantly displayed in real time. However, such information may also be selectively displayed as desired.

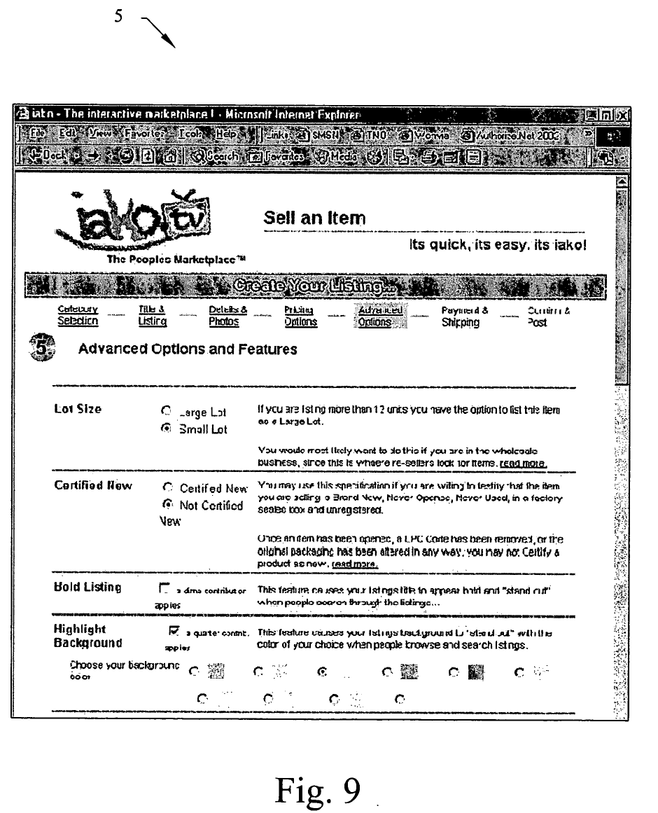

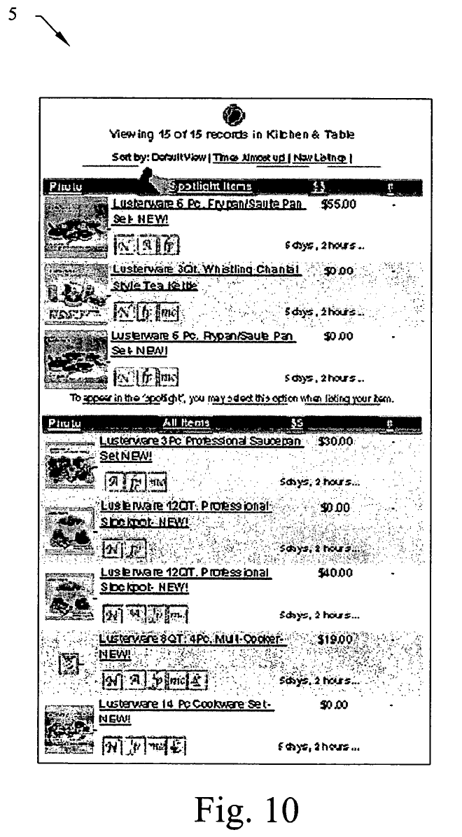

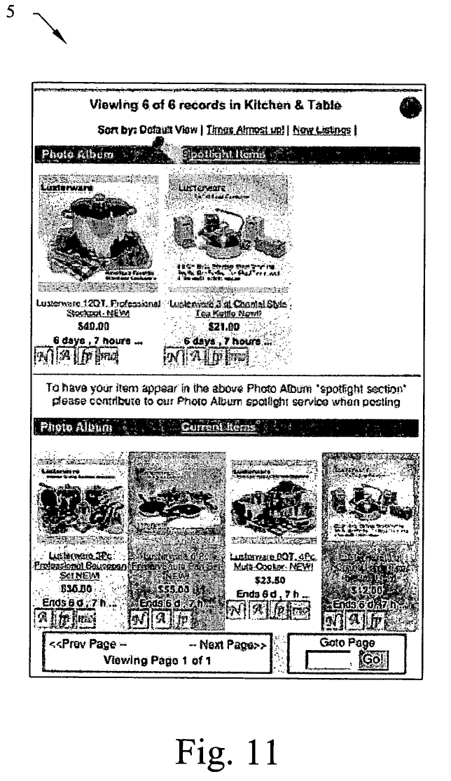

Referring to FIGS. 9 to 11, a system 5, in accordance with yet another aspect of the present disclosure, may be well suited for associating a particular color to a listed or posted item and/or service. The system 5 preferably gives an EMT site customer their choice of at least one color to associate with one or more of their transactional listings. Any of a variety of colors and/or color shades may be used. As shown, the EMT site customer may be provided a palette of colors to select from. The color palette may be based on any of a variety of known color programs. The selected colors may in turn be associated with any one or more of their listed items as a background color, a text/font color and/or other color associated identifier. The system 5 advantageously enables an EMT site customer to make a listed item stand out with respect to other listed items. In this aspect of the present disclosure, the color palette may utilize conventional RGB values such as 0, 0, 0 to 255, 255, 255 in decimal or #000000 to #FFFFFF in hexadecimal. As would be apparent to those skilled in the pertinent art, other color schemes may also be used.

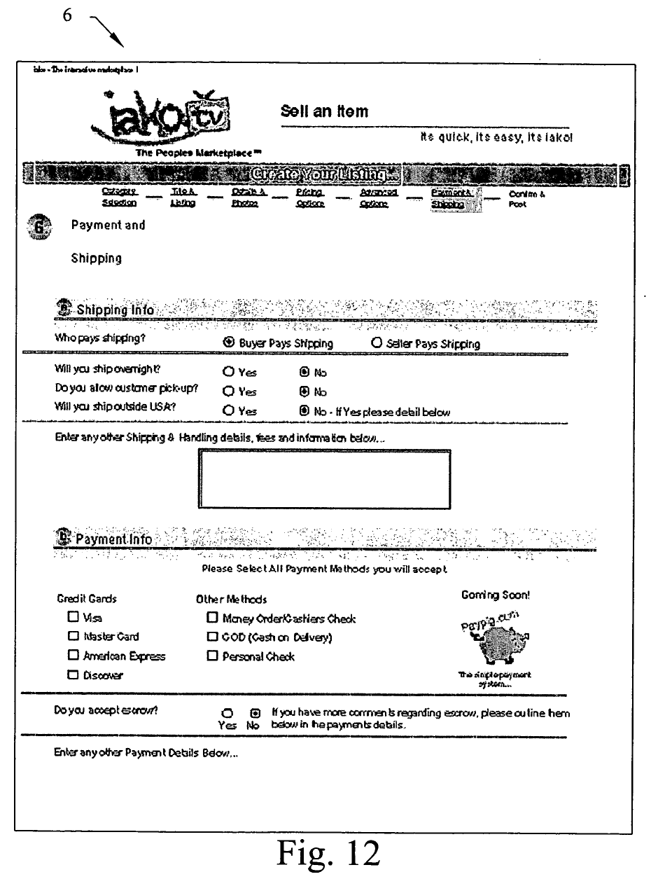

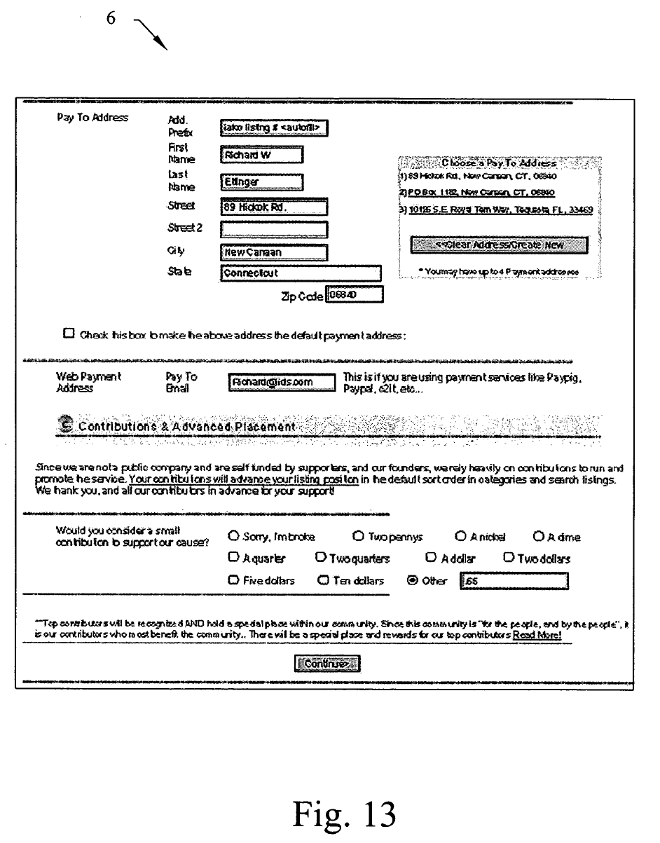

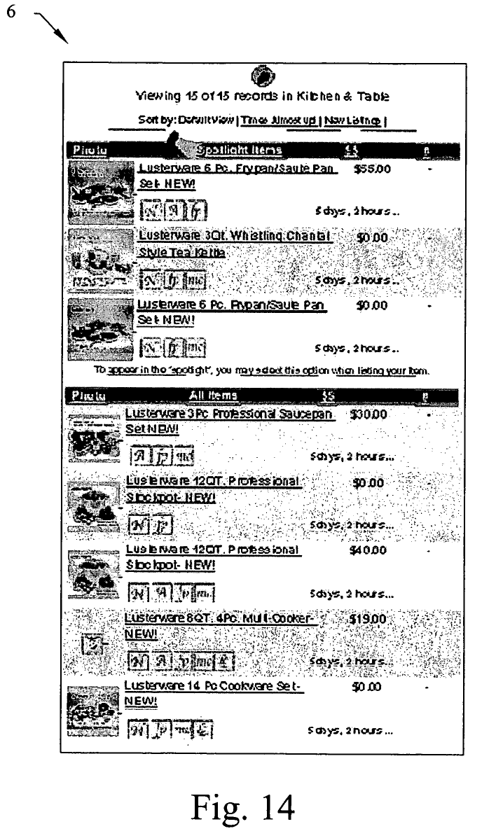

Referring to FIGS. 12 to 14, a system 6, in accordance with a further another aspect of the present disclosure may be well suited for paying for placement of transactional listings. The system 6 is preferably a dynamic system that allows EMT site customers to advance one or more transactional listings via contributions for one or more listed items and/or services. The contributions, in this aspect of the present disclosure, are preferably associated with listed items and/or services having a defined and/or a limited availability life, and/or are available only in a particular exchange or transaction.

The system 6 is preferably based on a cost or contribution per listing basis as opposed to conventional cost per click or cost per view methods. For example, when an EMT site customer lists an item and/or service for sale on a public EMT site, the system 6 will preferably provide the EMT site customer with an opportunity to make a contribution in association with the newly listed item and/or service. If the contribution is made, the newly listed item and/or service will be advanced for a predefined period of time such as, for example, for the life of the listing. Any of a variety of other predefined time periods may also be used. The system 6, in this illustrative aspect of the present disclosure, will preferably rank item and/or service listings according to contribution amount.

For example, if an EMT site customer lists an item and/or service with a nickel contribution to advance the placement thereof, the listed item and/or service will be posted or ranked before other, preferably related, items and/or services for which the contribution was less than a nickel and after those, preferably related, items and/or services for which the contribution was more than a nickel. If two or more items and/or services have equal contributions associated therewith, then such items and/or services will be posted or ranked by priority date. That is, items and/or services listed first by a date and/or timestamp will appear before items and/or services subsequently listed.

The system 6, in this aspect of the present disclosure, preferably may also take into account item and/or service listing subsections such as, for example, one or more featured sections that may be emphasized by placement above or before regular listing sections. The system 6 can rank any one or more of the subsections in a manner at least substantially similar to that previously described with respect to regular listings. The system 6 may be implemented automatically via a default setting, but as would be understood by those skilled in the pertinent art, the system 6 may alternatively be selectively implemented by an EMT site customer via any of a variety of techniques, e.g., a control link or button.

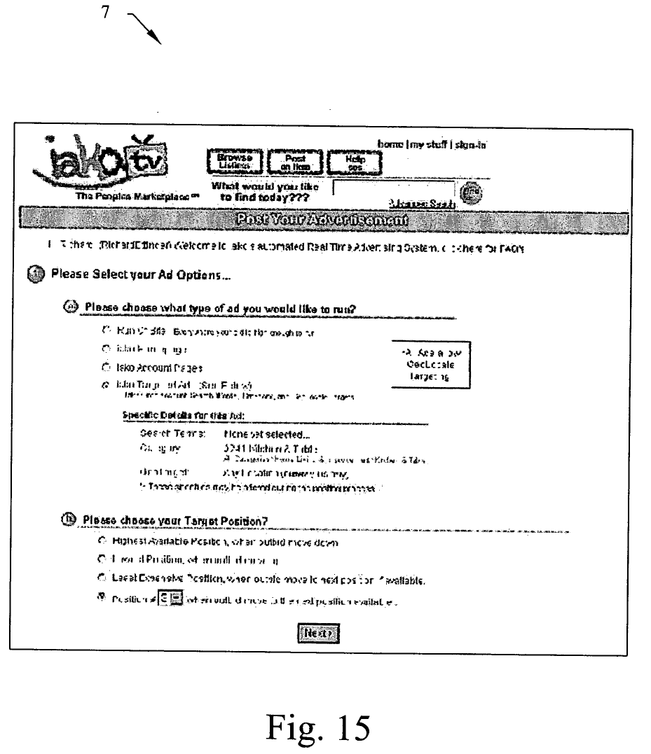

Referring to FIGS. 15 to 19, a system 7, in accordance with still a further aspect of the present disclosure, may be well suited for selective placement of advertising listings. The system 7 preferably allows EMT site customers to post one or more advertisements on a public EMT site according to their preference for a determined period of time. The period of time for which the EMT site customer's preferences are adhered to may be dependent on or be associated with the amount paid for such preferred posting. Also, the amount paid may be based on a cost per view, cost per click, cost per specified time period, cost per contribution and/or any combination of the same. One advantage provided by the system 7 is found in the greater flexibility and/or control the EMT site customer has in determining and/or taking advantage of the most effective ad placement locations. For example, in some instances, it may be most effective to post or place an ad for a particular item and/or service in a central portion of a site or webpage. While, in other instances, the particular item and/or service ad might be optimally placed along a perimeter of a webpage. Thus, the system 7 preferably enables the EMT site customer to post or place an ad for an item and/or service at any location, as desired, on a webpage.

In this aspect of the present disclosure, the system 7 can cooperate with any of a number of different advertising schemes such as, for example, a vertical column scheme, a wrapped stacked scheme, or a banner scheme. In the vertical column scheme, items and/or services are posted vertically one on top of another in a relatively narrow strip on either or both sides of a webpage. In the wrap stacked scheme, items and/or services are posted horizontally from one side of a webpage to the other preferably in conventional sentence reading format so that at least one line of posting may be stacked on another line of postings to form a paragraph of postings. In a banner scheme, items and/or services are typically sequentially displayed for predefined periods. These advertisement schemes help drive customer traffic to particular item and/or service listings.

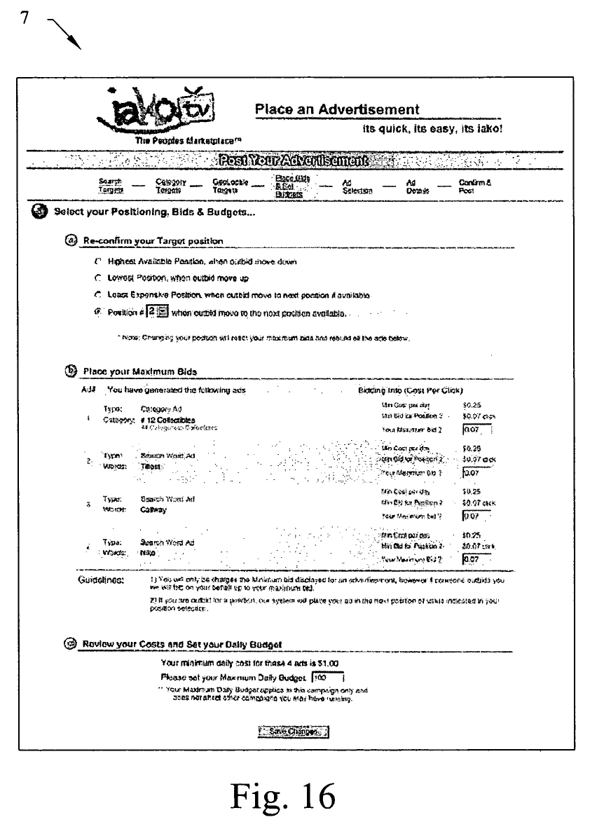

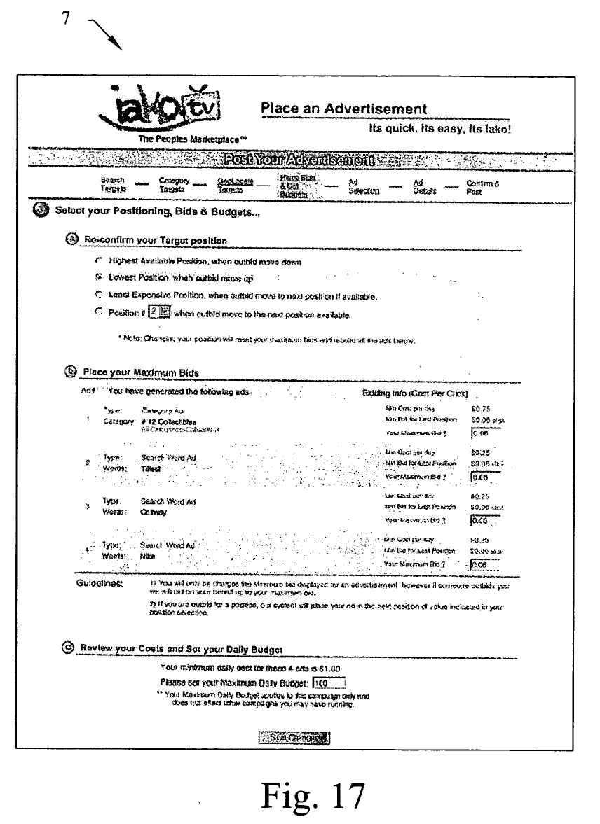

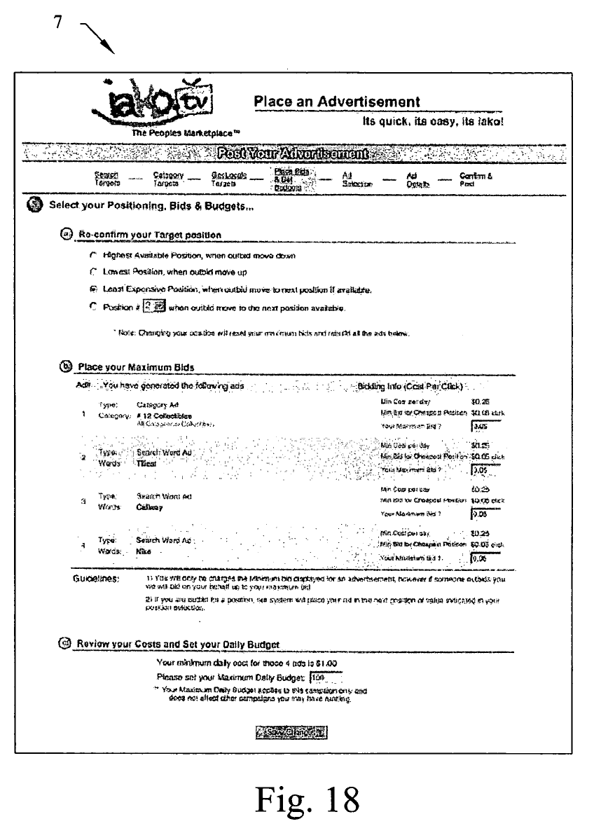

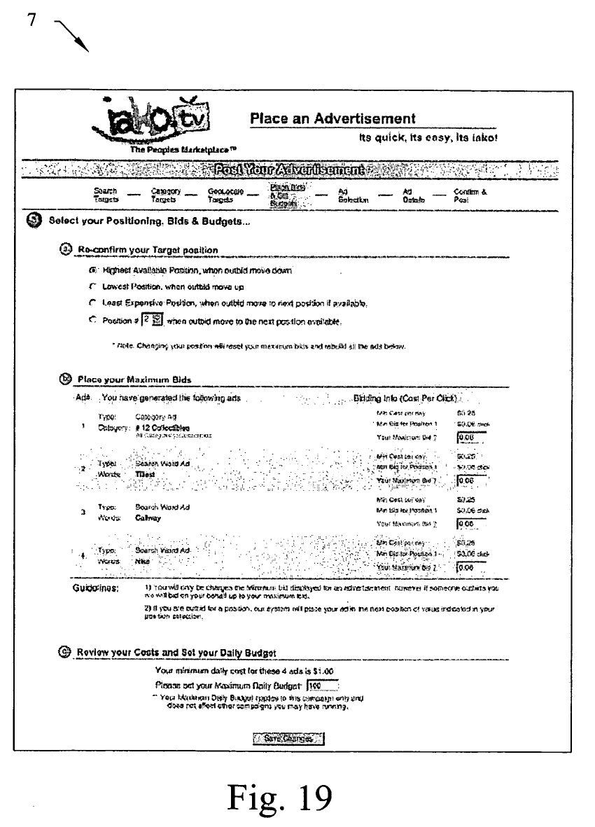

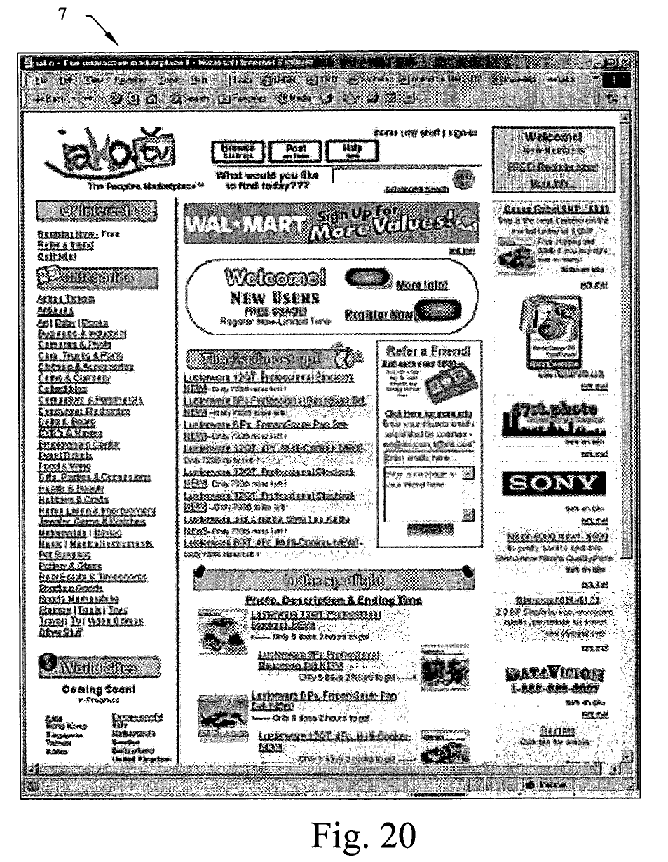

The system 7 preferably provides the EMT site customer with at least four placement/positioning options. As shown in FIG. 16, an EMT site customer may have an option to select at least one alternative placement/position should their preferred placement/position be made unavailable for any reason (e.g., customer is outbid). With this option, the EMT site customer can, for example, select to go up or down, left or right, or ahead or behind of their preferred placement/position, depending on the applicable advertising scheme. Also, as shown in FIG. 17, an EMT site customer may have an option to select a “Lowest Position”. With this option, the posted item and/or service is automatically placed/positioned in the last spot and will automatically move up, left or ahead, depending on the applicable advertising scheme, as the last place/position becomes unavailable for any reason (e.g., customer is outbid). Further, as shown in FIG. 18, an EMT customer may have the option to select a “Least Expensive Position”. With this option, the posted item and/or service is automatically placed/positioned in the most economic spot and will automatically move to the next available place/position as the most economic position becomes unavailable for any reason (e.g., placement is time dependent). Still further, as shown in FIG. 19, an EMT site customer may have an option to select a “Highest Available Position”. With this option, the posted item and/or service is automatically placed/positioned in the highest spot and will be automatically moved down, right or back, depending on the applicable advertising scheme, as the highest position becomes unavailable for any reason (e.g., customer is outbid). The system 7, in other aspects of the present disclosure may provide additional and/or alternative options to provide even greater flexibility in determining optimal item and/or service ad placement. FIG. 20 shows exemplary ad placement modes in a banner format and vertical column format.

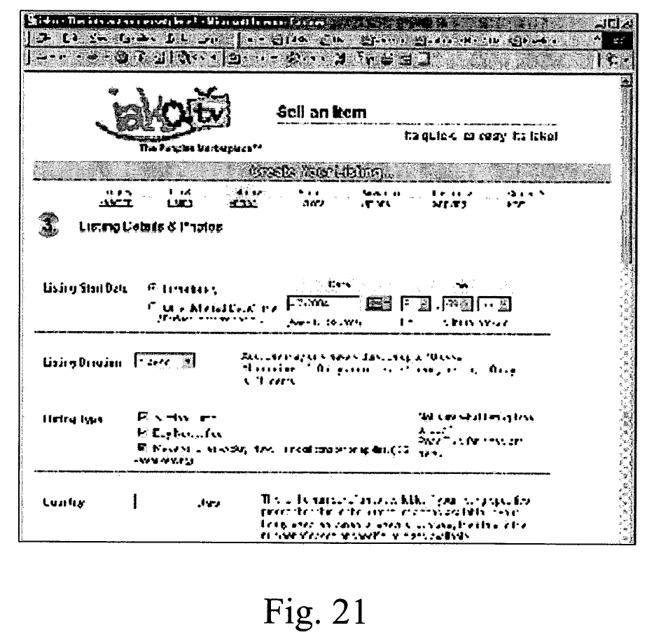

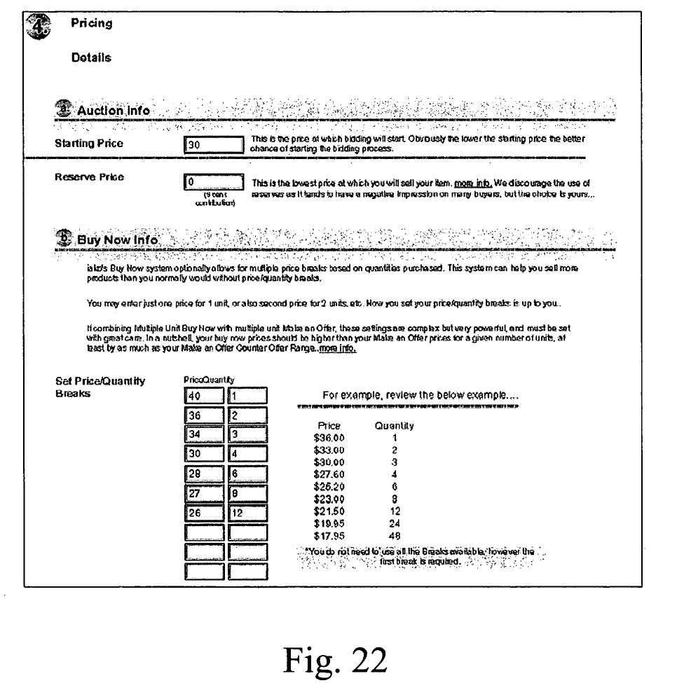

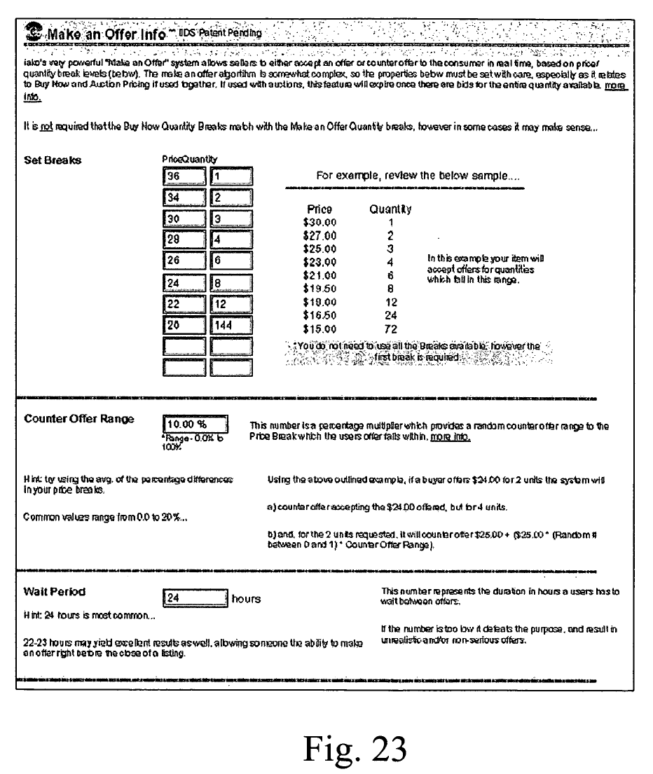

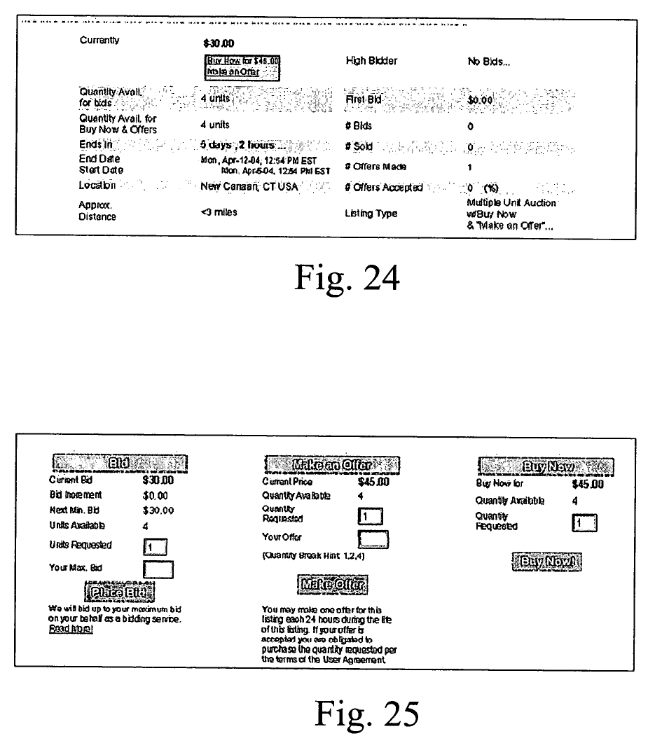

Referring to FIGS. 21 to 24, in a preferred aspect of the present disclosure, a system 8 is suitable for allowing EMT customers to combine up to three (3) selling methodologies that may run simultaneously. When combining the three selling methodologies on a single item and/or service for sale, specific details such as, for example, quantities and expiration dates must be handled with care and in such a format to allow a user to combine “Auction” listings”, “Make an Offer” listings (discussed in more detail in pending patent application entitled “Automated Offer-Based Negotiation System And Method”, filed on Apr. 15, 2004, hereby incorporated by reference), and “Buy Now” fixed price listings to all simultaneously interact with respect to one or more items and/or services for sale in one or more listings.

Preferably, the system 8 takes into account the “Total Quantity” available, the “Quantities Available” for the “Buy Now” instant purchase feature, and the “Quantities Available” for real time offers via the “Bid” auction feature and/or the “Make an Offer” feature, as well as the expirations dates as appropriate. Thus, when the “Bid” auction feature is combined with the “Make an Offer”, and a multiple price instant purchase system, the system 8 preferably accounts for and displays to both buyers and sellers, the “Total Quantity” available for an item, the “Quantity Available” for the “Bids”, and the “Quantity Available” for “Buy Now” and “Offers”. When an item and/or service is purchased using the “Make an Offer” feature, or the “Buy Now” feature, these quantities are preferably reduced both from “Quantities Available” for “Auctions” as well as “Total Quantity Available” and displayed to both the buyers and sellers of the products in real time. When an item and/or service is bid on via the “Bid” auction feature, the quantities of such item and/or service are locked and become no longer available in the “Make an Offer” feature or the “Buy Now” instant purchase feature. Thus, the “Quantity Available” for “Offers” and “Buy Now” instant purchase is reduced, however the “Total Quantity Available” is preferably not reduced since the items and/or service are still subject to bid by other, higher bidder. In the event that the “Quantity Available” for “Offers” or “Buy Now” instant purchase reaches zero (0), then the “Make an Offer” feature and the “Buy Now” instant purchase feature close down prior to the expiration of the “Bid” auction. Likewise, if all items and/or services available are exhausted via the “Buy Now” instant purchase feature or the “Make and Offer” feature, the “Bid” auction terminates prior to its expiration.

The present disclosure thus provides for unique and advantageous systems/methods for various electronic business transactions. The disclosed systems/methods may be implemented via a computer network and may be used for the sale of products and/or services. The present disclosure is particularly applicable to the sale of relatively low cost fungible products or services, such as housewares and/or other mass-produced items, although the systems/methods may be advantageously used in virtually any sales context. Also, although the disclosed systems/methods have been described with reference to exemplary aspects, the disclosure is not to be limited to such exemplary aspects. Rather, the disclosed systems/methods are susceptible a wide range of applications and variations, without departing from the spirit and scope of the presently disclosed and claimed invention.

1. A system for online marketplace data sharing, comprising:
one or more electronic marketplace transaction (EMT) sites that appear independent; and
a single platform suitable for operatively connecting to said EMT sites so that while said EMT sites appear independent such sites share data,
wherein said EMT sites may be divided into sub-groups.

2. A system according to claim 1, further comprising integrating a listing module of a particular electronic marketplace transaction (EMT) site on one or more third party sites, wherein said integration includes:
means for integrating a list of one or more discrete items or services on a third party site based on relative content of the third party site in real time;
means for enabling one or more transaction methodologies; and
means for segregating or displaying said list of discrete items according to one or more criteria.

3. A system according to claim 1, further comprising functionality that is adapted to sell keywords or phrases for a fixed cost, said selling functionality including:
means for displaying one or more items associated with an electronic marketplace transaction (EMT) site when certain keywords or phrases are provided;
means for pricing one or more keywords or phrases; and
means for allowing a customer of said EMT site to purchase one or more keywords or phrases at a fixed price.

4. A system according to claim 1, further comprising functionality that is adapted to allow a customer of an electronic marketplace transaction (EMT) site to list one or more items to be sold via an automated technique that accounts for two or more price/quantity breaks, said listing functionality including:
means for allowing an EMT site customer to purchase or list items or services for sale with two or more price/quantity combinations;
means for displaying said two or more price/quantity break combinations;
means for displaying a total quantity of available items for instant purchase; and
means for tracking said total quantity of available items for instant purchase.

5. A system for associating a particular color to an electronically displayed item, comprising:
means for selecting a desired color;
means for associating a selected color with a particular item or service; and
means for electronically displaying said particular item or service in association with said selected color.

6. A system for paying for placement of transactional listings, comprising:
means for advancing one or more transactional listings for one or more items or services in accordance with an associated contribution amount;
means for controlling the duration during which said one or more items or services will be advanced;
means for ranking said one or more item or service listings according to contribution amount;
means for ranking said one or more items or services according to time listed; and
means for providing and ranking said one or more item or service listing subsections.

7. A system according to claim 6, further comprising functionality for selective placement of advertisements, said placement functionality including:
means for posting one or more advertisements for items or services on a public electronic marketplace transaction (EMT) site according to preferences of an EMT site customer;
means for cooperating with different advertising schemes; and
means for relocating said advertisements as certain placements or positions become unavailable.

8. A system according to claim 6, further comprising functionality that supports simultaneous multiple electronic marketplace transaction selling methodologies, said supporting functionality including:
means for providing an instant purchase feature;
means for providing a bid purchase feature;
means for providing a negotiated purchase feature; and
means for utilizing said instant purchase feature, said bid purchase feature and said negotiated purchase feature simultaneously with respect to one or more items or services for sale,
wherein said utilizing means accounts for and readily displays current quantities available for purchase in real time.
